(19) United States
(12) Patent Application Publication
(10) Pub. No.: US 2011/0172861 A1
(43) Pub. Date: Jul. 14, 2011

(54) SYSTEMS AND METHODS FOR CONVERTING IMPORTED VEHICLES TO MEET REGULATORY REQUIREMENTS AND TO IMPROVE SAFETY

(76) Inventor: Gary Starr, Santa Rosa, CA (US)

(21) Appl. No.: 12/728,229

(22) Filed: Mar. 21, 2010

Related U.S. Application Data
(60) Provisional application No. 61/295,040, filed on Jan. 14, 2010.

(51) Int. Cl. B23P 17/00; G06F 7/00; H02J 7/00

(52) U.S. Cl. 701/22; 29/401.1; 320/109

(57) ABSTRACT

Systems and method are disclosed for modifying an imported vehicle to meet regulatory requirements by installing a vehicle charger with a charge interlock and a master cut-off and a master fuse on the vehicle; modifying the vehicle to comply with government safety requirement; limiting a vehicle Gross Vehicle Weight Rating (GVRW) to less than approximately 1,361 kg.; and limiting the maximum speed of the vehicle to between approximately 32 km/hr and approximately 40 km/hr.

This application claims priority to Provisional Application Ser. No. 61/295040 filed Jan. 14, 2010, the content of which is incorporated by reference.

### BACKGROUND

The present invention relates to modified electric vehicles for regulatory and safety compliance.

The rising cost of oil and global warming indications have sensitized manufacturers and consumers to the need to be energy efficient and environmentally responsible. As a result, modern electric cars are becoming popular again. Electric cars use electric motors which receive their energy from batteries and thus the batteries need to be periodically recharged. In general, it is cheaper, more efficient, and less polluting to plug-in an electric car for a few hours for a battery recharge, than to try and overcome the (nearly, if not completely, impossible) burden of forcing the car to produce its own electrical power.

In a parallel trend, the last decade has seen foreign imports continue to gain substantial market share putting an increasing pressure on the domestic car manufacturers. One reason is that some of the offshore manufacturers have access to low cost manufacturing labor sources. However, significant safety issues and other legal/regulatory issues exist for importing cars that are not designed to US standards and regulations. For example, most motor vehicles manufactured for consumption outside the United States do not conform to US bumper, emission and other safety standards. The importing cars into the US from any country requires that they meet safety standards as outlined in the Motor Vehicle Safety Act of 1966 as revised in 1988 in the Imported Vehicle Safety Compliance Act; to air pollution control standards as outline in the Clean Air Act of 1968 and amended in 1977 and again in 1990; and to the bumper standards of the 1972 Motor Vehicle Information and Cost Savings Act that were effective in 1978, among others. The Department of Transportation (DOT) and Environmental Protection Agency (EPA) also specify emission requirements for vehicles operated in the US.

If the vehicle does not meet United States standards, it must be exported, brought into compliance or destroyed.

### SUMMARY

In one aspect, systems and methods are disclosed for modifying an imported vehicle to meet regulatory requirements by installing a vehicle charger with a charge interlock and a master cut-off and a master fuse on the vehicle; modifying the vehicle to comply with U.S. consumer standards.

In one implementation, the vehicle is modified to conform to Rule 500, as known as Low Speed Vehicles. The Rule includes limiting a vehicle Gross Vehicle Weight Rating (GVRW) to less than (3000 pounds) approximately 1,361 kg. ; and limiting the maximum speed of the vehicle to between approximately 32 km/hr and approximately 40 km/hr. To meet this standard these vehicles must be speed limited to no more than 25 mph.

Other implementations of the above aspect can include checking for conforming head lamps, turn signal lamps, tail lamps, stop lamps, reflex reflectors, driver side exterior mirror, passenger side exterior mirror or interior mirror, parking brake, windshield, and following NHTSA Vehicle Identification Number (VIN), seat belt compliance and certification labels.

In another aspect, a modified electric vehicle includes regulatory compliant head lamps, turn signal lamps, tail lamps, stop lamps, reflex reflectors, driver side exterior mirror, passenger side exterior mirror or interior mirror, parking brake, windshield, Vehicle Identification Number (VIN), seat belt and certification label; a speed limiter to limit a maximum speed to between approximately 32 km/hr and approximately 40 km/hr and to no more than 25 mph; a power plug adapted to be plugged into a power line; a plurality of hub wheel motors mounted to the frame, each hub wheel motor rotating a wheel; a controller coupled to the plurality of hub wheel motors; or the placement of a dc or ac single drive motor, a charger coupled to the power plug; a battery coupled to the charger; and a power interlock coupled to the power plug, the controller and the charger, the power interlock disabling the controller if the power plug is plugged into AC power and other wise disenabling the controller to operate at least the motor(s).

Implementations of the above aspect may include one or more of the following. The electric vehicle has a power plug adapted to be plugged into a power line; a plurality of hub wheel motors, each hub wheel motor rotating a wheel; a controller coupled to the plurality of hub wheel motors; a charger coupled to the power plug; and a battery coupled to the charger. The vehicle includes a power interlock coupled to the power plug, the controller and the charger, where the power interlock disables the controller if the power plug is plugged into line power and other wise enables the controller to operate at least the motors.

In another aspect, a method to recharge an electric vehicle includes providing a power interlock coupled to the power plug, the controller and the charger; and disabling the controller if the power plug is plugged into line power and other wise enabling the controller to operate at least the motors.

Advantages of the system may include one or more of the following. The system provides a safe way to convert imported vehicles to meet US standards and regulation. The system also adds U.S. consumer demanded safety features for imported electric vehicles. By disabling the vehicle controller with the interlock, safety is ensured in that a driver cannot turn on or power the drive system while the vehicle main battery pack is charging, thus preventing the driver from accidentally driving way while the car is plugged into the power line. This avoids risks of electric shocks or fire to the vehicle/occupants. The vehicle controller is re-enabled only when the power cord is unplugged from the AC power line so that the vehicle can be safely driven. A master disconnect switch is provided inside the passenger department for an emergency or for servicing. A main fuse is also provided to provide the vehicle from power surges or accidental power shorts.

The modifications convert a vehicle from another country and allow the vehicle to pass DoT NHTSA standards and EPA standards by removing all emission related and gas related devices and making the vehicle compliant with LSV requirements. In some cases, the tires of the vehicles are changed with DoT certified tires, to meet various State standards. Similarly, the lights of certain vehicles are also replaced with DoT compliant lights to meet various State standards. After modification, the car is registered with the DoT and NHTSA and/or applicable state regulatory agencies. In addition to conforming to regulatory standards, certain modifications provide features such as electric heating and defrosting to provide comfort to drivers and thus enhance the marketing of such vehicles in the USA.

### BRIEF DESCRIPTION OF THE DRAWINGS

FIG. 1 shows an exemplary process for converting an imported electric vehicle to enhance safety as well as to meet regulatory requirements.

FIG. 2A shows an exemplary power interlock system.

FIG. 2B shows one implementation of the power interlock system.

FIG. 2C shows one implementation of a master power cut-off device.

FIG. 3 shows an exemplary process for power interlock and power-cutoff.

FIG. 4 shows an exemplary power interlock used in an electric vehicle with hub wheel motors.

### DESCRIPTION

The following description of various disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

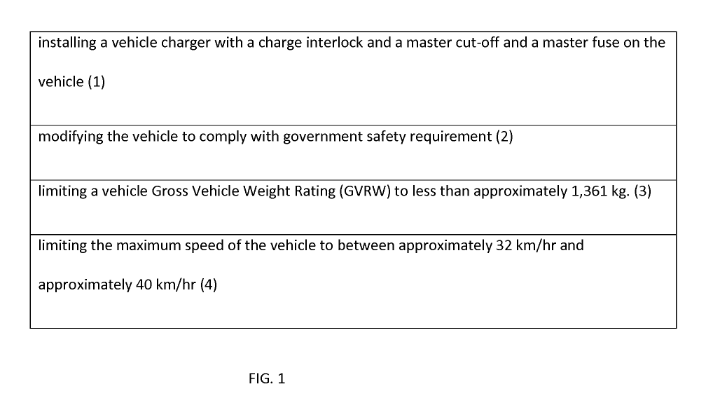

FIG. 1 shows an exemplary process for converting an imported electric vehicle to enhance safety as well as to meet regulatory requirements. First, an electric vehicle is shipped from another country into the US. The vehicle is typically designed for driving in a foreign country and is not designed to meet US regulatory and safety requirements. The vehicle is upgraded as follows. First, a technician installs a vehicle charger with a charge interlock and a master cut-off and a master fuse on the vehicle (1). Next, the vehicle is modified to comply with government safety requirement (2). The car is then tested to ensure that the vehicle has a Gross Vehicle Weight Rating (GVRW) of less than approximately 1,361 kg. (3). Additionally, the maximum speed of the vehicle is checked to ensure that the maximum speed has been limited to between approximately 32 km/hr and approximately 40 km/hr (4).

In one embodiment, the vehicle is updated to conform to National Highway Traffic Safety Administration 49 CFR Part 571. The rule establishes a new class of 4-wheeled vehicles, called LSVs, and excludes them from passenger car class. LSVs are 4-wheeled vehicles, other than trucks, whose maximum speed exceeds 20 but is not greater than 25 miles per hour. By removing them from the passenger car class, the rule relieves manufacturers of LSVs of the need they would otherwise have of complying with the full range of FMVSSs for those classes and substitutes Standard No. 500 as the only applicable FMVSS. With the exception of the warning label, which was not adopted, LSVs are required to have all the safety features and equipment proposed in the NPRM, including seat belts, plus two additional items added in response to comments: a VIN, and a reflex reflector on the rear. However, as an alternative to an AS-1 windshield, an AS-5 plastic windshield may be used. More details on this rule can be found at http://www.nhtsa.dot.gov/cars/rules/rulings/lsv/lsv.html.

In one implementation, the vehicle can be retrofitted as follows:

a) install a USA 110 volt charging receptacle

b) a charge interlock system to prevent the vehicle from being driven when plugged in

c) installing an adequate heating system that can provide both defrosting and heating for the occupants

d) installing a US compatible on board universal charging system that can work with any USA 110 or 220 outlet.

e) installing various US safety systems such as a master fuse and a master manual disconnect.

f) placing the batteries in position so the center of gravity is correct

More details of one conversion checklist are shown for another exemplary modification to an exemplary vehicle in Appendix A. In this example, the parts of the vehicle checked in operation 2 for compliance with the regulation includes:

Headlamps (S5(b)(1))

Turn signal lamps, front and rear (S5(b)(2))

Tail lamps (S5(b)(3))

Stop lamps (S5(b)(4))

Reflex reflectors, one red on each side, one on rear (S5(b)(5))

Drivers side exterior mirror (S5(b)(6))

Passenger side exterior mirror or interior mirror (S5(b)(6))

Parking brake (S5(b)(7))

Windshield, AS-1 or AS-4 composition (S5(b)(8))

Vehicle Identification Number (VIN) (S5(b)(9))

Seat belt assemblies—Type 1 or 2 (S5(b)(10))

Certification label (Part 567)

In 3, the technician can check when Occupant Weight plus loaded is added to the unloaded vehicle weight that GVWR meets the total measured vehicle weight, and that the tires are rated to handle this weight, and that the total GVWR is less than 3000 pounds.

The modifications convert a vehicle from another country and allow the vehicle to pass DoT NHTSA standards and EPA standards by removing all emission and gas related devices and making the vehicle compliant with LSV requirements. In some cases, the tires of the vehicles are changed with DoT certified tires. Similarly, the lights of certain vehicles are also replaced with DoT compliant lights. After modification, the car is registered with the DoT and NHTSA and/or applicable state regulatory agencies. In addition to conforming to regulatory standards, certain modifications provide features such as electric heating and defrosting to provide comfort to drivers and thus enhance the marketing of such vehicles.

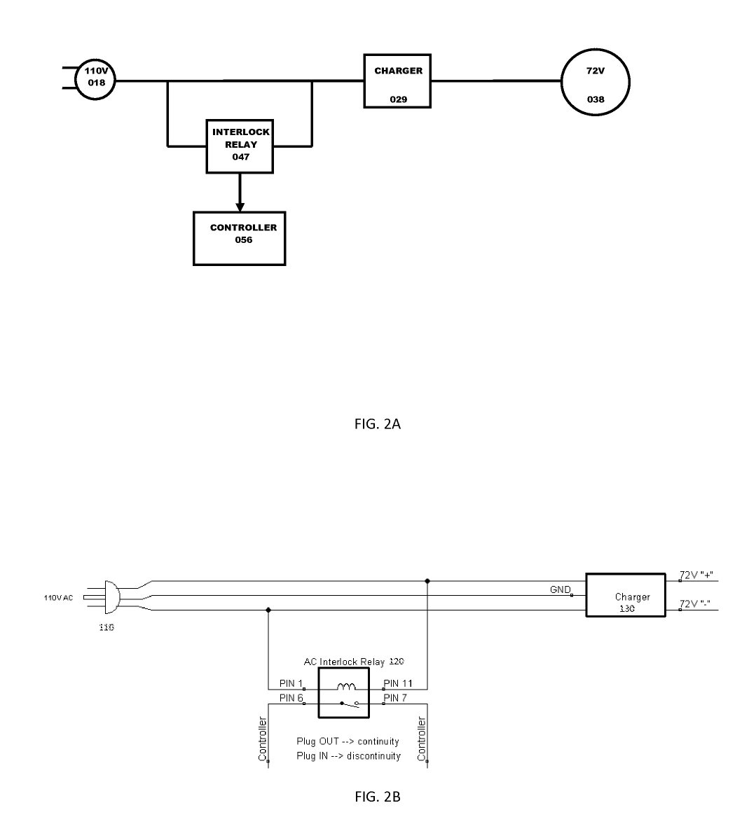

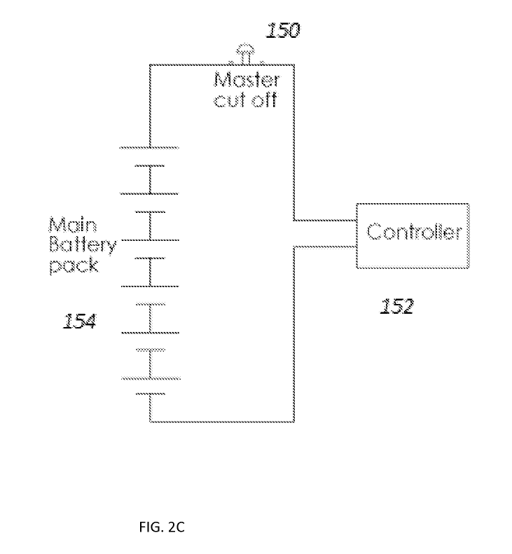

FIG. 2A shows an exemplary power interlock for electric vehicles. In the embodiment of FIG. 2A, the electric vehicle is powered by a plurality of hub wheel motors which are motors directly positioned in the wheels and thus can directly drive the electric vehicle with little or no transmission gears. The motors are powered by battery packs that need recharging. The charger is powered by the AC power line when a power cord from the vehicle is plugged into the AC socket.

Referring now to FIG. 2A, the AC Interlock Block 047 feature of the vehicle includes a plug 018 to connect the charging electronics into an AC 110V power supply. The connected plug 018 supplies power to a charger 029. The charger 029 converts AC power to a DC power supply and the DC power is directed to a vehicle main battery pack 038. As the vehicle main battery pack 038 is charging the AC Interlock relay 047 disables a vehicle controller 056. By disabling the vehicle controller 056 with the Interlock Relay 047 the vehicle is ensured that a driver cannot turn on or power the drive system while the vehicle main battery pack 038 is charging. When the driver or operator disconnects the plug 018 from the AC 110V power source, the Interlock relay 047 enables the vehicle controller 056 to operate. By enabling the vehicle controller 056 only when the power cord is unplugged from the AC power line, the vehicle can be safely driven.

FIG. 2B shows one implementation of the power interlock system. In this implementation, a power plug 110 can be plugged into a wall socket to get AC power. The AC power is delivered to a charger 130, and the power lines of the AC wires are provided to an AC interlock relay 120. The relay also receives a control signal from a controller (not shown) at one pin (pin 6) and, depending on the relay control signal, can either connect the control signal to another pin (pin 7) of the relay or can simply disconnect the control signal. During operation, if AC power is sensed, the relay disconnects pin 6 from pin 7 to disable the controller. Alternatively, if AC power is not sensed (not plugged in), the relay 120 connects pin 6 to pin 7 to enable the controller to operate normally. The AC Interlock prevents power from being provided to the vehicle while the vehicle is plugged in for charging. The AC interlock will be placed under the passenger seat and connected to the AC source.

The relay 120 can be a 220V model such as AIKS's relay model ART3F 110V. The unit is an electromagnetism relay with coil voltages at 380V AC/220VDC, contact capacity of 10A 24VDC/240VAC. The contact form is 3Z with a socket mounting type.

FIG. 2C shows one implementation of a master power cut-off device. A master cut-off switch 150 is provided between control electronics 152 and battery 154. The master cut-off switch allows a driver or user in the cab to remove all power and disable the vehicle in case of a major problem such as a fire or circuit failure that can pose a hazard.

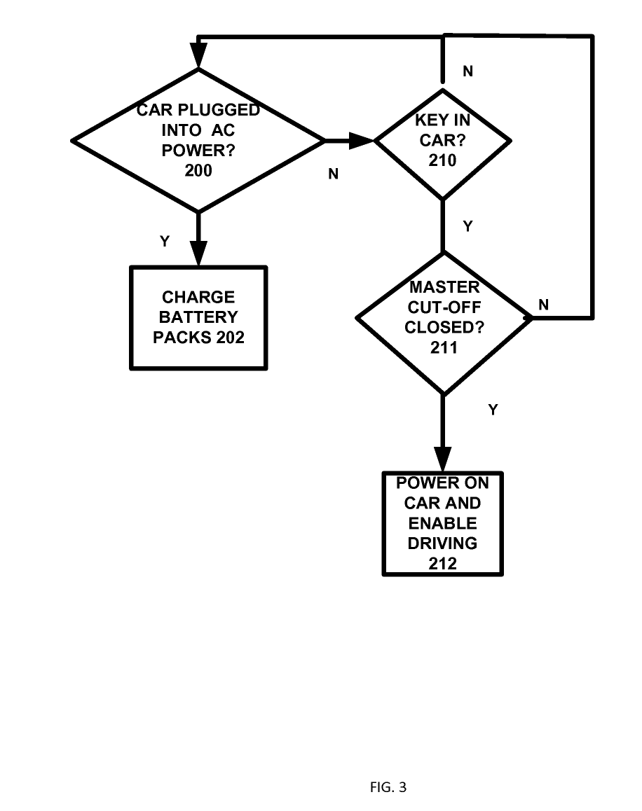

FIG. 3 shows an exemplary power interlock process. In this process, the system detects whether the vehicle has been plugged into wall power for recharging purposes (200). If so, the battery packs (primary or secondary packs) are charged (202). If not, the process proceeds to 210 where it checks if an ignition key is in the car (210). Next, the process checks if the master cut off switch is closed (211). The switch is a normally closed one. So, the controller will get power normally unless the master switch is opened. If the user actives the cut off switch, the process loops back to 200. Alternatively, if the cut-off switch has not been activated, the vehicle is powered on and the controller is enabled to allow the driver to operate the vehicle (212). If not, the process loops back to 200 to continue the battery charging operation.

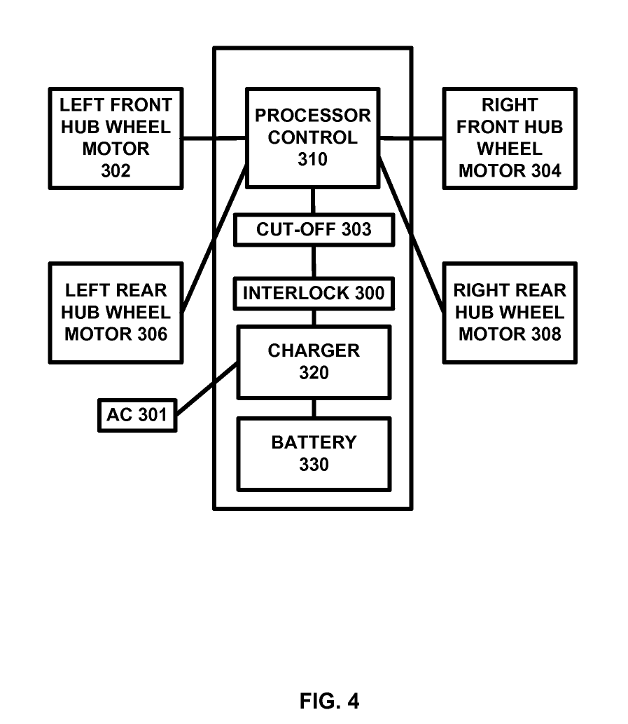

FIG. 4 shows a power interlock used in an electric vehicle with hub wheel motors 302-308. Even though 4 wheel motors are used for all wheel drive, 2 wheel motors can be mounted on the front or the back. The motors 302-308 and the power interlock 300 are controlled by a vehicle processor 310 to provide transportation to passengers located in a cab (not shown). A cut-off device 303 allows manual user shut-down of the entire vehicle. The interlock 300 determines if the vehicle is plugged into the AC line through a plug 301. The plug 301 provides power to a charger 320 which charges battery pack(s) 330. If the vehicle is plugged into line power, the controller 310 is disabled by disconnecting a controller signal. If not, the controller 310 is connected for normal operation. In this manner, charging of the battery can be safely done.

The hub motor of FIG. 4 is designed to be small in size. The compact motor assembly is mounted in conjunction with the hub of the car. The motor assembly includes a self contained unit which includes a rotationally driven motor housing that is connected directly to the tire supporting rim of the car wheel. Rotation of the motor housing will result in similar rotation of the tire supporting rim of the wheel. The motor housing has an internal chamber and within that internal chamber is located a stator and a rotor. The stator is fixedly mounted onto a center shaft which passes through the motor housing which is fixedly mounted to the car. The rotor is to be rotated by the electrical energy being supplied to the stator with this rotation being transferred through the drive shaft.

The exemplary hub wheel motor system includes a motor enclosed by a hub cap and a tire supporting rim. A rubber wheel can be mounted on the rim. The back of the hub cap has an opening through which a cable is inserted there through to provide power as well as control signals to the motor. The motor has outer, ring-shaped permanent magnets (stator) that rotate while the inner metallic core (rotor) is fixed. When the motor is switched on, the static rotor stays still while the stator spins around it. A tire is attached to the motor, and as the outer part of the motor rotates, the wheel (or wheels) powers the vehicle forward.

The electric car with hub-wheel motors can be the Alias, available from ZAP,. of Santa Rosa, Calif. The Alias is 100% electric, 100% of the time. Recharging is simple and effortless via any 110V outlet at home or on the road. The Alias has aerodynamic contours, low profile, wide stance with double-wishbone suspension, and sport styling. The vehicle can also be a truck with hub-wheel or regular DC or AC motors called ZAP Truck XL. Roomy, durable, rugged yet whisper quiet, the ZAPTRUCK XL is the affordable green solution for fleet operations. The electric truck is a utilitarian workhorse providing a roomy cab for two and a convertible bed/platform for moving up to 1600 lbs. of cargo during off-road use. The vehicle is ideal for corporate campuses, warehouses, universities, factories, municipal operations and around the ranch or farm.

In one embodiment, a central controller senses temperature conditions and issues a command to maintain constant temperature given the weather condition and the occupant's desired temperature range. The central controller linearly ramps down the fan when the temperature is too high and vice versa. The user, through the user interface, can override the processor when conditions change or for any reason. In this manner, the vehicle can increase its efficiency and user comfort while minimizing environmental pollution.

The software controlling the car can be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to control or embedded system software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments, are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. A modified electric vehicle, comprising:
a. regulatory compliant head lamps, turn signal lamps, tail lamps, stop lamps, reflex reflectors, driver side exterior mirror, passenger side exterior mirror or interior mirror, parking brake, windshield, Vehicle Identification Number (VIN), seat belt and certification label;
b. a speed limiter to limit a maximum speed to between approximately 32 km/hr and approximately 40 km/hr; and not more than 25 mph
c. a power plug adapted to be plugged into a power line;
d. a plurality of hub wheel motors mounted to the frame, each hub wheel motor rotating a wheel;
e. a controller coupled to the plurality of hub wheel motors;
f. a charger coupled to the power plug;
g. a battery coupled to the charger;
h. a power interlock coupled to the power plug, the controller and the charger, the power interlock disabling the controller if the power plug is plugged into line power and other wise enabling the controller to operate at least the motors; and
i. a master cut off switch coupled to the controller to cut off battery voltage in case of emergency and isolate the high voltage pack.

2. The vehicle of claim 1, wherein the battery comprises a high voltage primary battery.

3. The vehicle of claim 2, wherein the battery voltage is 72 volts or more.

4. The vehicle of claim 1, comprising a low voltage secondary battery coupled to the charger.

5. The vehicle of claim 4, wherein the low voltage secondary battery voltage is 12 volts or less.

6. The vehicle of claim 1, wherein the charger comprises a battery temperature sensor to adjust charging rate.

7. The vehicle of claim 1, wherein the power interlock comprises a relay.

8. The vehicle of claim 7, wherein the relay disconnects a controller circuit if the power plug is plugged into the power line.

9. The vehicle of claim 7, wherein the relay enables a controller circuit if the power plug is not plugged into the power line.

10. The vehicle of claim 1, wherein the power interlock comprises a switch or a transistor.

11. A method for modifying an imported vehicle to meet regulatory requirements, comprising:
installing a vehicle charger with a charge interlock and a master cut-off and a master fuse on the vehicle;
modifying the vehicle to comply with government safety requirement;
limiting a vehicle Gross Vehicle Weight Rating (GVRW) to less than approximately 1,361 kg.; and
limiting the maximum speed of the vehicle to between approximately 32 km/hr and approximately 40 km/hr.

12. The method of claim 11, comprising providing safety with the charge interlock, master cutoff, and master fuse.

13. The method of claim 11, comprising changing a windshield marking to a Department of Transportation (DoT) approved marking;

14. The method of claim 11, comprising changing a seat belt to a DoT approved seatbelt with markings;

15. The method of claim 11, comprising changing light reflectors to the DoT standard.

16. The method of claim 11, comprising affixing a vehicle identification number (VIN) that conforms to the DoT NHTSA standard.

17. The method of claim 11, comprising changing vehicle to meet a gross vehicle weight (GVW) requirement.

18. The method of claim 11, comprising changing NHTSA register for identifying a manufacturer, a vehicle type, an agent and a distributor.

19. The method of claim 11, comprising providing a heater system or an air conditioner (A/C) system for comfort.

20. The method of claim 11, comprising checking for conforming head lamps, turn signal lamps, tail lamps, stop lamps, reflex reflectors, driver side exterior mirror, passenger side exterior mirror or interior mirror, parking brake, windshield, Vehicle Identification Number (VIN), seat belt and certification label.
